(19) United States
(12) Patent Application Publication
(10) Pub. No.: US 2021/0004264 A1
(43) Pub. Date: Jan. 7, 2021

(54) METHOD FOR DISPLAYING USE HISTORY AND ELECTRONIC DEVICE FOR PERFORMING SAME

(71) Applicant: Samsung Electronics Co., Ltd., Gyeonggi-do (KR)

(72) Inventors: Dongchul HWANG, Gyeonggi-do (KR); Suyong KIM, Gyeonggi-do (KR); Junseok PARK, Gyeonggi-do (KR); Jonghwa LEE, Gyeonggi-do (KR)

(21) Appl. No.: 16/976,131

(22) PCT Filed: Mar. 19, 2019
(86) PCT No.: PCT/KR2019/003193

§ 371 Date: Aug. 27, 2020

(30) Foreign Application Priority Data
Apr. 11, 2018 (KR) 10-2018-0042038

(51) Int. Cl. G06F 9/48; G06F 9/46; G06F 11/34

(52) U.S. Cl. CPC G06F 9/4881; G06F 11/3466; G06F 9/461

(57) ABSTRACT

According to various embodiments of the disclosure, disclosed is an electronic device that includes a display, a memory, and a processor electrically connected to the display and the memory, wherein the processor is configured to receive a first input of a user executing a first application, to execute at least one process for executing the first application in response to the received first input, to acquire first information including an ID and a start time of the executed at least one process, to receive a second input of the user executing a second application, and to display a name of the first application corresponding to the ID on the display in a form of a calendar in response to the received second input, based on the start time. Additional various embodiments identified through the specification are possible.

### TECHNICAL FIELD

Embodiments disclosed in the disclosure relate to a method for displaying a use history and an electronic device for performing the same.

### BACKGROUND ART

With the development of information technology (IT), various types of electronic devices, such as personal computers (PCs), laptops, smartphones, tablet personal computers (PCs), and the like, have been widely used.

A user may perform various and complex tasks through various applications executed in electronic devices. For example, a user may surf a web through an internet browser application, and may create and edit various documents through a word processor application. As another example, a user may enjoy various types of games through a game application, and may watch a movie through a video reproducing application.

### DISCLOSURE

### Technical Problem

When a user performs various tasks as described above, there are cases where the user ends the task without completing the task. For example, when the user watches a movie through the video reproducing application, the user may end the watching at an intermediate point of the movie without completing the watching. In another example, when a user performs a task that generates a document through a word processor, the user may end the task without completing the task generating the document and may continue the task thereafter. As another example, when a user performs a retrieve task on a specified subject through an internet browser, the user may end the task without completing the task and may continue the task thereafter.

As described above, when the user stops the continuous task and wants to perform the task again later, the user may need information about a use history of the past. For example, the user may need information about the use history such as a stopped time of the task, a content of the task that is performed in the past, a location where intermediate results of the task performed in the past are stored, or the like.

In addition, the user may need not only the most recent information on the use history but also information on the task performed in the past. For example, when the user frequently performs different tasks in the same application, the user may need all of the use histories on each task. For example, the user may watch the first video and the second video through the video application. When the user ends watching at a first point of the first video and ends watching at a second point of the second video, the user may need information about the first point of the first video as well as information about the second point of the second video that is the most recent use history.

When the electronic device does not provide the above information to the user, the user may need to perform the task performed in the past from the beginning again, which may cause inefficiency of the task. In addition, when it is necessary to separately identify the above information in each application, it may cause inconvenience that the user cannot recognize past task history at a glance, and may cause inefficiency of a work.

Embodiments disclosed in the disclosure are intended to provide an electronic device for solving the above-described problem and the problems raised by this document.

### Technical Solution

An electronic device according to an embodiment disclosed in the disclosure includes a display, a memory, and a processor electrically connected to the display and the memory, and wherein the processor is configured to receive a first input of a user executing a first application, to execute at least one process for executing the first application in response to the received first input, to acquire first information including an ID and a start time of the executed at least one process, to receive a second input of the user executing a second application, and to display a name of the first application corresponding to the ID on the display in a form of a calendar in response to the received second input, based on the start time.

In addition, a method of displaying a use history of a user in a form of a calendar, according to an embodiment disclosed in the disclosure includes receiving a first input of the user executing a first application, executing at least one process for executing the first application in response to the received first input, acquiring the first information including an ID and a start time of the executed at least one process, receiving a second input of the user executing a second application, and displaying a name of the first application corresponding to the ID on a display in the form of the calendar in response to the received second input, based on the start time.

### Advantageous Effects

According to embodiments disclosed in the disclosure, an electronic device may effectively provide a history about a task performed by a user through various applications. The electronic device may provide a user with a high ease of use, through which the user may increase work efficiency and continuity. In addition, various effects may be provided that are directly or indirectly identified through this document.

### DESCRIPTION OF DRAWINGS

FIG. 1 is a block diagram of an electronic device according to an embodiment.

FIG. 2 is a flowchart illustrating a method of providing a use history to a user by an electronic device according to an embodiment.

FIG. 3 is a flowchart illustrating a method of providing a use history to a user by an electronic device according to another embodiment.

FIG. 4 is a flowchart illustrating a process of an electronic device storing a user's use history through each module according to an embodiment.

FIG. 5 is a flowchart illustrating a method of an electronic device storing a user's use history according to an embodiment.

FIG. 6A illustrates a screen of displaying a user's use history by an electronic device to a user, according to an embodiment.

FIG. 6B illustrates a screen of displaying a user's use history by an electronic device to a user, according to another embodiment.

FIG. 7 is a block diagram of an electronic device in a network environment according to various embodiments of the disclosure.

In connection with the description of the drawings, the same or similar reference numerals may be used for the same or similar components.

### MODE FOR INVENTION

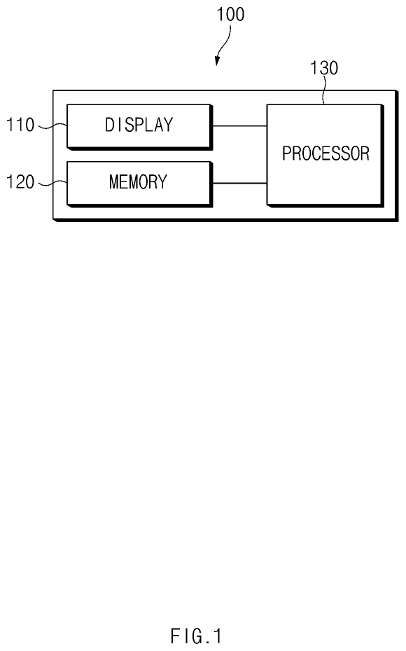

FIG. 1 is a block diagram of an electronic device according to an embodiment.

Referring to FIG. 1, an electronic device 100 may include a display 110, a memory 120, and a processor 130. According to various embodiments, the electronic device 100 may omit some of the components illustrated in FIG. 1, or may further include components not illustrated in FIG. 1. For example, the electronic device 100 may further include at least one of an input device that receives a user input, for example, a touch panel, a mouse, or a keyboard.

The display 110 may output at least one content or item (e.g., text, an image, a video, an icon, a widget, or a symbol). The display 110 may include, for example, a liquid crystal display (LCD), a light emitting diode (LED) display, an organic light emitting diode (OLED) display, a micro-electro-mechanical system (MEMS) display, or an electronic paper display.

According to an embodiment, the display 110 may include a touch panel (or a touch sensor) or may be integrated with the touch panel. In this case, the display 110 may also be referred to as a touch screen panel (TSP) or a touch screen display panel.

The memory 120 may be a storage medium in which instructions executed by a processor are stored or outputs generated by execution of the instructions are stored. For example, the memory 120 may store instructions that cause the processor 130 to acquire an ID (or identification information) of a process executed by a user. As another example, the memory 120 may store an ID (or identification information) of the process acquired by the processor 130 in the operation.

According to various embodiments, the memory 120 may include a volatile memory or a nonvolatile memory. For example, the memory 120 may include the nonvolatile memory in which the instructions that acquires the ID (or identification information) of the process are stored or the volatile memory in which the ID (or identification information) of the acquired process is stored.

The processor 130 may be electrically connected to the components included in the electronic device 100 to execute operations or data processing related to the control and/or communication of the components included in the electronic device 100. In one embodiment, the processor 130 may be electrically connected to the display 110 and the memory 120 to output a designated screen on the display 110 or to store designated data in the memory 120. In another example, the processor 130 may receive the user input and may store the received user input in the memory 120. In another example, the processor 130 may transfer data stored in the memory 120 to the display 110 to output the designated screen on the display 110.

According to an embodiment, the processor 130 may execute specified instructions stored in the memory 120. For example, the processor 130 may execute a monitoring instruction to confirm whether a process event of a specified condition occurs. For another example, the processor 130 may execute an instruction to acquire the specified information from the process event of the specified condition and to store the acquired information in the memory 120. For another example, the processor 130 may execute an instruction to output a user's use history to the display 110, based on the acquired information.

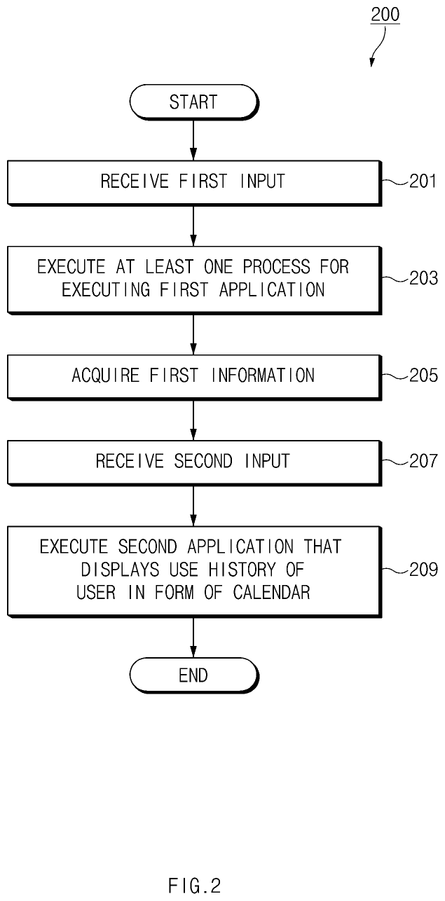

FIG. 2 is a flowchart illustrating a method of providing a use history to a user by an electronic device according to an embodiment.

Referring to FIG. 2, a method 200 in which the electronic device 100 provides the use history to a user may include operations 201 to 209. According to an embodiment, the processor 130 included in the electronic device 100 may be configured to perform operations 201 to 209.

In operation 201, the electronic device 100 may receive a first input of a user. According to an embodiment, the first input may be a user input of executing a first application. According to various embodiments, the first application may include an internet browser application, a word processor application, a game application, or a video reproducing application. In various embodiments, the first application is not limited to the above-mentioned embodiment. The first application may include various applications that may be executed in an operating system (e.g., Windows, Linux, iOS, Android, etc.) of the electronic device 100.

According to an embodiment, the first input may have various forms. For example, the user may provide the first input to the electronic device 100 by touching the touch panel of the electronic device 100 or by providing a pressure of a specified intensity or more. As another example, the user may provide the first input to the electronic device 100 through an external input device such as a mouse or a keyboard.

In operation 203, the electronic device 100 may execute at least one process for executing the first application in response to the received first input. According to various embodiments, the process required for execution of the first application may be at least one or more.

In operation 205, the electronic device 100 may acquire first information related to the executed at least one process. According to an embodiment, the first information may include an ID of the at least one process and a time at which execution of the at least one process is started. According to an embodiment, the electronic device 100 may store the first information in the memory 120.

According to an embodiment, the electronic device 100 may acquire the first information with respect to one of at least one process for executing the first application. For example, when the execution of the first process and the execution of the second process are required for the execution of the first application, the electronic device 100 may acquire the first information from any one of the first process or the second process. According to an embodiment, the any one of process may be predetermined based on a type of the first application. Information about the predetermined process may be stored in the memory 120.

According to an embodiment, the first information may further include other information. In one embodiment, the first information may further include at least one of a type of a first application, information about a file executed in the first application, or information about a file generated in the first application.

For example, when the first application executed in response to the first input is the video reproducing application, the first information may include a type of the video reproducing application or a file name of a video file played by the video reproducing application.

For another example, when the first application executed in response to the first input is an internet browser application, the first information may include an internet address accessed from the internet browser application.

According to various embodiments, the information about the executed or generated file may include at least one information of a file name of the executed or generated file, a modification time of the executed or generated file, a storage location of the executed or generated file, or a size of the executed or generated file.

In operation 207, the electronic device 100 may receive a second input of the user. According to an embodiment, the second input may be a user input for executing a second application.

In operation 209, the electronic device 100 may execute the second application that displays the user's use history in a form of a calendar, based on the first information. According to an embodiment, the second application may be an application that provides the user's use history in the form of the calendar in response to the received second input. For example, the second application may be an application that displays the name of the first application corresponding to the ID of the at least one process acquired in operation 205 in the form of the calendar, based on a time at which execution of the at least one process is started.

According to an embodiment, the second application may display not only the name of the first application but also various information included in the first information acquired in operation 205 in the form of the calendar on the display 110, based on the start time. For example, the second application may be an application in which a type of the video reproducing application or the file name of the played video file is displayed in the form of the calendar. As another example, the second application may be an application in which a type of the internet browser application or the accessed internet address is displayed in the form of the calendar.

According to an embodiment, there may be a temporal disconnection between operations 201 to 205 and operations 207 to 209 in operations 201 to 209. For example, the electronic device 100 may repeatedly perform operations 201 to 205, based on receiving a plurality of first inputs. As another example, after performing operations 201 to 205, the electronic device 100 may receive a third input that terminates the first application from the user and may perform an operation corresponding to the third input.

According to an embodiment, the second input of the user may not occur while the electronic device 100 repeatedly performs operations 201 to 205 or receives the third input of the user and performs a corresponding operation. When the user's second input does not occur, the electronic device 100 may not perform operations 207 to 209. Thereafter, when the second input of the user occurs after an unspecified time elapses, the electronic device 100 may perform operations 207 to 209.

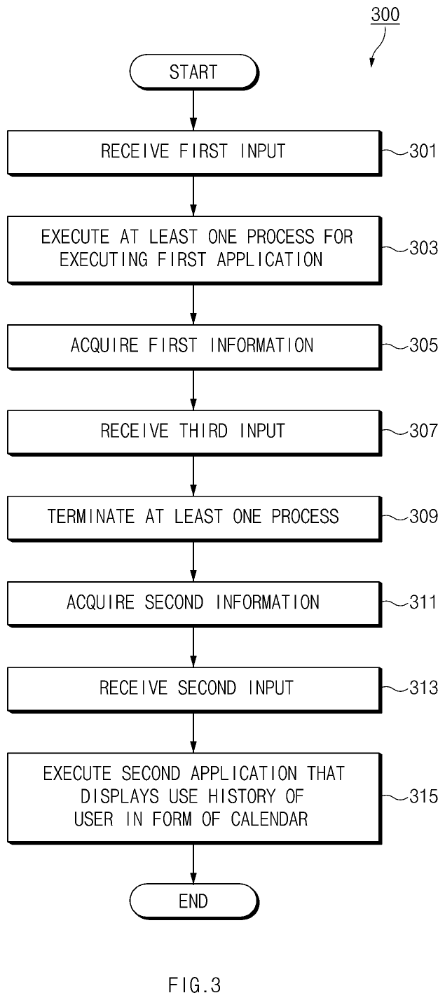

FIG. 3 is a flowchart illustrating a method of providing a use history to a user by an electronic device according to another embodiment.

Referring to FIG. 3, a method 300 of providing the use history to the user by the electronic device 100 may include operations 301 to 315. According to an embodiment, the processor 130 included in the electronic device 100 may be configured to perform operations 301 to 315. In the description of FIG. 3, contents overlapping with the description of FIG. 2 may be omitted.

According to an embodiment, operations 301 to 305 may be the same as or similar to operations 201 to 205 illustrated in FIG. 2. For example, the electronic device 100 may receive the first input of the user for executing the first application, may execute at least one process in response to receiving the first input, and may acquirer the first information related to the process.

In operation 307, the electronic device 100 may receive the third input of the user. According to an embodiment, the third input may be a user input for terminating the first application.

According to an embodiment, the third input may be formed in various forms in the same or similar manner as the first input received in operation 301 (or operation 201 of FIG. 2).

In operation 309, the electronic device 100 may terminate at least one process for executing the first application in response to the received third input. The at least one process may be the same as at least one process executed in operation 303 (or operation 203 of FIG. 2).

In operation 311, the electronic device 100 may acquire second information related to the terminated at least one process. According to an embodiment, the second information may include an ID of the at least one process and a time at which execution of the at least one process is finished. According to an embodiment, the electronic device 100 may store the second information in the memory 120.

According to an embodiment, the electronic device 100 may acquire the second information with respect to one of at least one process for executing the first application. For example, when the execution of the first process and the execution of the second process are required for the execution of the first application, the electronic device 100 may acquire the second information from any one of the first process or the second process. According to an embodiment, the any one process may be predetermined based on the type of the first application. Information about the predetermined process may be stored in the memory 120.

According to an embodiment, the second information may further include other information. According to an embodiment, the second information may further include at least one of a type of the first application, information about a file executed in the first application until the end time, or information about a file generated in the first application until the end time.

For example, when the first application is the video reproducing application, the second information may include a type of the video reproducing application, a file name of a video file played by the video reproducing application, or a point at which reproducing of the video file is stopped.

As another example, when the first application is the internet browser application, the second information may include an internet address accessed from the internet browser application until the end time.

According to various embodiments, the information about the executed or generated file may include at least one information of a file name of the executed or generated file, a modification time of the executed or generated file, a storage location of the executed or generated file, or a size of the executed or generated file.

In operation 313, the electronic device 100 may perform an operation that is the same as or similar to operation 207 of FIG. 2.

In operation 315, the electronic device 100 may execute a second application that displays the user's use history in the form of the calendar, based on the first information and the second information. In operation 315, the electronic device 100 may perform an operation similar to operation 209 of FIG. 2. For example, the electronic device 100 may execute the second application in response to the reception of the second input.

In operation 315, the electronic device 100 may display the use history based on the second information as well as the first information, unlike operation 209 of FIG. 2. For example, the electronic device 100 may further include information about a file generated in the application and may display the information on the display 110 in the form of the calendar.

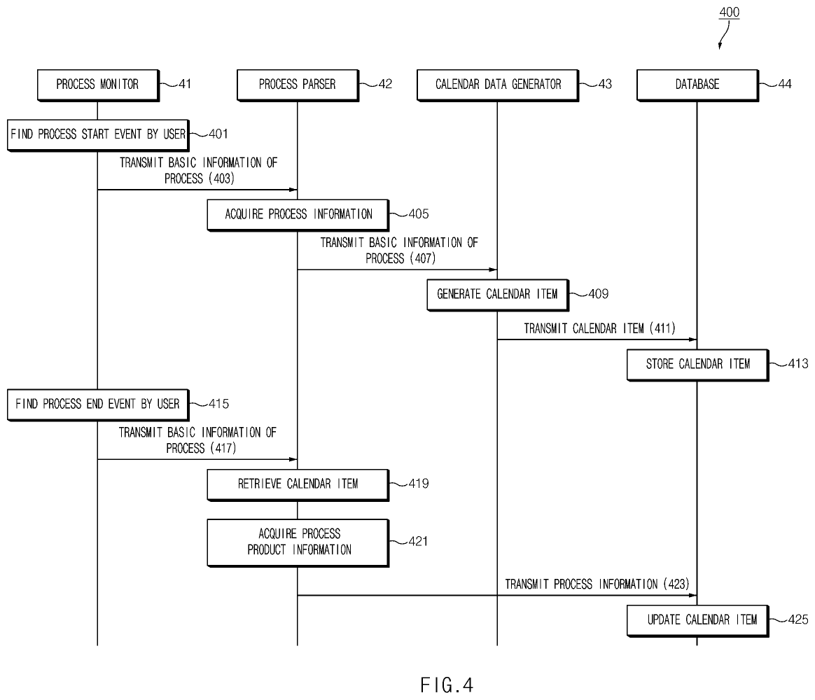

FIG. 4 is a flowchart illustrating a process of an electronic device storing a user's use history through each module according to an embodiment.

Referring to FIG. 4, an operation of the processor 130 for a method 400 of storing the user's use history is illustrated. According to an embodiment, the processor 130 may include a plurality of modules. The processor 130 may include a process monitor, a process parser, a calendar data generator, and a database as the plurality of modules.

The process monitor may detect a process event at specified time intervals. For example, the process monitor may detect an event in which at least one process is executed or terminated by the user.

The process parser may analyze a process corresponding to the process event detected by the process monitor module and may acquire information. For example, the process parser may acquire an ID of a process executed by the user or information about a start time of execution.

The calendar data generator may generate a calendar item corresponding to the ID of each process, based on the information acquired by the process parser module. In one embodiment, the calendar item may be data in which the acquired information is implemented in the form of the calendar. For example, the calendar item may be data in which the acquired information is arranged based on a specified date or a specified time.

The database may be a space in which the calendar item generated by the calendar data generator is stored. In one embodiment, the database may be the memory 120. In one embodiment, the database may update information acquired additionally in the process parser to the calendar item.

In operation 401, the process monitor may find a process that is occurred by the user. In one embodiment, the process monitor may identify running processes at the specified time intervals. For example, the process monitor may invoke a specified function at the specified time intervals using a polling method.

For example, when the operating system of the electronic device 100 is Windows, the process monitor may invoke an EnumWindos API (user32.dll) at the specified time intervals. The process monitor may acquire a process handle through the EnumWindos API (user32.dll) and may acquire information about a process through a GetWindowThreadProcessld API. When executed by the user, the process monitor may find a process executed by the user because values of a MainWindowHandle and a MainWindowTitle of the process are exist in the process monitor.

For another example, when the operating system of the electronic device 100 is Android, the process monitor may identify a list of an application being used by invoking a getRunningAppProcesses API of an android.app.ActivityManager class at the specified time intervals. When not executed by the user, the process monitor may find a process executed by the user because a getSystemService API additionally exists in addition to the getRunningAppProcesses API.

The process monitor may identify a process executed by a user by monitoring a specific API as described above. In other words, the process monitor may identify the start event of the process executed by the user.

In operation 403, the process monitor may transmit basic information of the process corresponding to the found start event to the process parser. The basic information may be, for example, an ID (or identification information) of a process.

In operation 405, the process parser may acquire the first information of the process executed by the user, based on the received basic information of the process. The first information may be the same as or similar to the first information acquired in operation 205 of FIG. 2.

In operation 407, the process parser may transmit the acquired first information to the calendar data generator.

In operation 409, the calendar data generator may generate the calendar item, based on the received first information. In one embodiment, the calendar item may be plural, and each calendar item may correspond to an ID of each process. In other words, the calendar data generator may generate a plurality of different calendar items each corresponding to the ID of one process.

The information included in the first information depending on a flow of a date or time may be arranged in the calendar item. For example, information such as a name, a type, a generated file, or the like of an application executed by the process at a start time when the process is started may be recorded in the form of the calendar.

In operation 411, the calendar data generator may transmit the generated calendar item to the database.

In operation 413, the database may store the received calendar item.

In operation 415, the process monitor may find an end event of the process terminated by the user. For example, the process monitor may track the ID of the process generated by the user in operation 401 in the EnumWindos API (user32.dll) or the getRunningAppProcesses API. The process monitor may determine that the process is terminated when the ID of the process is not found in the APIs. In other words, the process monitor may find the end event through monitoring of the process.

In operation 417, the process monitor may transmit the basic information of the process corresponding to the found end event to the process parser. The basic information may be, for example, an ID (or identification information) of the process.

In operation 419, the process parser may retrieve the same calendar item, based on the received basic information. For example, the process parser may retrieve the calendar item corresponding to the ID of the process.

In operation 421, the process parser may acquire product information from the terminated process. The product information, for example, may be the same as or similar to the second information acquired in operation 311 of FIG. 3.

In operation 423, the process parser may transmit the acquired product information to the database. In one embodiment, the process parser may transmit information about the calendar item retrieved in operation 419 along with the product information to the database.

In operation 425, the database may update the received product information to the calendar item corresponding to the ID of the process. For example, the database may update the product information to the calendar item and may store the updated calendar item.

As described above, the electronic device 100 may detect a process started by the user and a process terminated by the user through operations 401 to 425, and may acquire information about the user's use history from the process. The electronic device 100 may implement the acquired use history information in the form of the calendar and store the acquired use history information in the database.

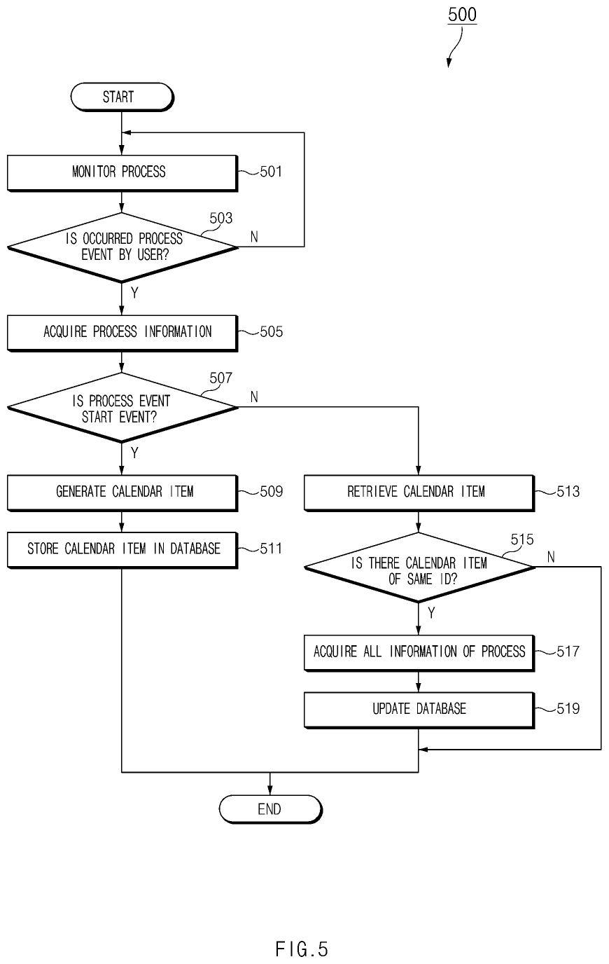

FIG. 5 is a flowchart illustrating a method of an electronic device storing a user's use history according to an embodiment.

Referring to FIG. 5, a method 500 for storing the use history of the user by the electronic device 100 may include operations 501 to 519. According to an embodiment, the processor 130 included in the electronic device 100 may be configured to perform operations 501 to 519. In the description of FIG. 5, content overlapping with the description of FIGS. 2 to 4 may be omitted.

In operation 501, the electronic device 100 may monitor a process. The electronic device 100 may monitor the process at the specified time intervals. For example, the electronic device 100 may acquire the process handle at the specified time intervals and may acquire information of a running process.

In operation 503, the electronic device 100 may determine whether the process event is occurred by the user. The process event may include a case in which a new process is executed or a case in which a process previously executed is terminated. When a process event occurs, the electronic device 100 may perform operation 505. When the process event does not occur, the electronic device 100 may perform operation 501 again.

In operation 505, since the process event occurs, the electronic device 100 may acquire the process information of the process event. The process information may be information on whether at least one process is started or terminated. According to an embodiment, the process information may be the same as or similar to the first information acquired in operation 205 of FIG. 2.

In operation 507, the electronic device 100 may determine whether the process event is a start event based on the acquired process information. When the process event is the start event, the electronic device 100 may perform operation 509. When the process event is not the start event, for example, when the process event is the end event, the electronic device 100 may perform operation 513.

In operation 509, the electronic device 100 may generate the calendar item, based on the process information acquired in operation 505. Operation 509 may be the same as or similar to operation 409 of FIG. 4.

In operation 511, the electronic device 100 may store the generated calendar item in the database. Operation 511 may be the same as or similar to operation 413 of FIG. 4.

In operation 513, the electronic device 100 may determine the process event as the end event rather than the start event. The electronic device 100 may retrieve the calendar item generated by the start event corresponding to the end event. According to an embodiment, the electronic device 100 may retrieve whether there is the calendar item by a process having the same ID as the process corresponding to the end event. Operation 513 may be the same as or similar to operation 419 of FIG. 4.

In operation 515, the electronic device 100 may determine whether there is the calendar item having the same ID. When there is the calendar item of the same ID, the electronic device 100 may perform operation 517. When there is no calendar item of the same ID, the electronic device 100 may terminate the operation.

In operation 517, the electronic device 100 may acquire all information of a process corresponding to the end event. For example, the electronic device 100 may acquire the second information in the same or similar manner as in operation 311 of FIG. 3.

In operation 519, the electronic device 100 may update the information acquired in operation 517 in the database. In other words, the electronic device 100 may update the acquired information to the calendar item and may store the updated calendar item in the database again.

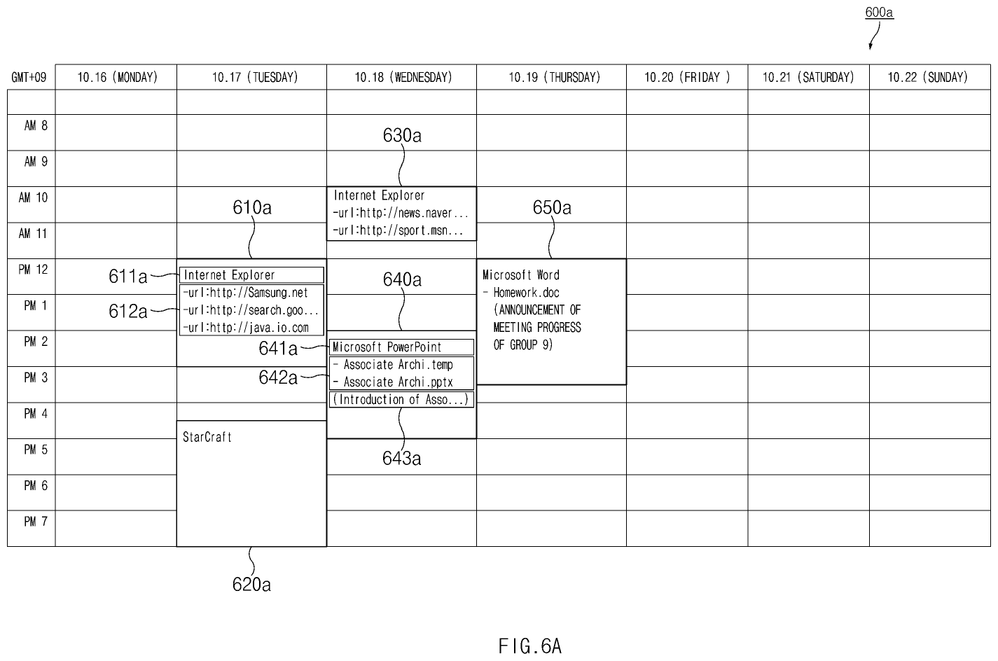

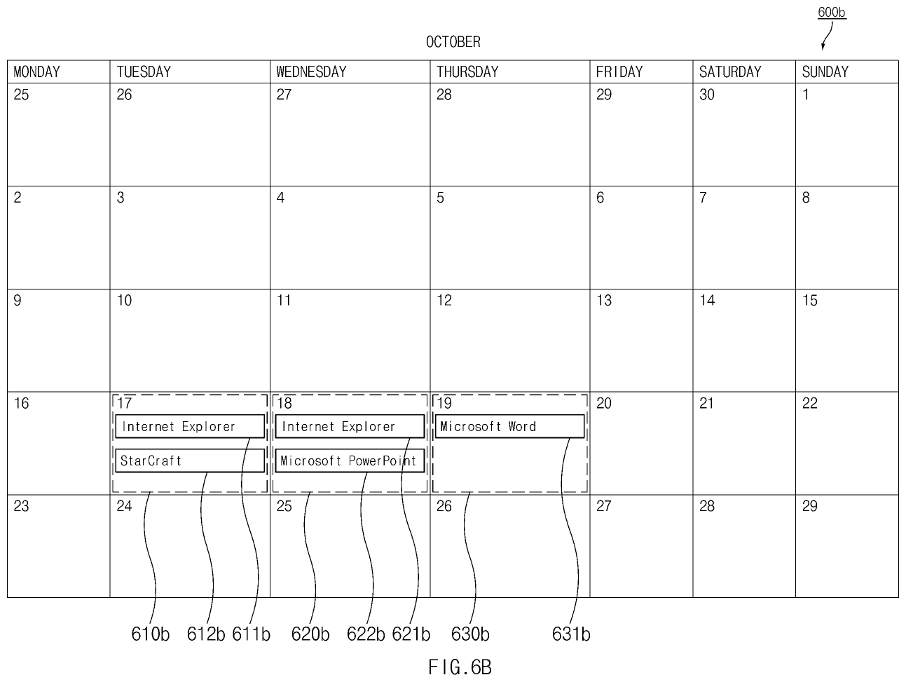

FIG. 6A illustrates a screen of displaying a user's use history by an electronic device to a user, according to an embodiment. FIG. 6B illustrates a screen of displaying a user's use history by an electronic device to a user, according to another embodiment.

Referring to FIGS. 6A and 6B, the electronic device 100 may display a user's usage history 600a and 600b in various forms of calendars. According to an embodiment, FIGS. 6A and 6B may be screens displayed on the display 110 of the electronic device 100.

According to an embodiment, as illustrated in FIG. 6A, the electronic device 100 may display user's usage history 610a, 620a, 630a, 640a, and 650a in units of time. For example, the electronic device 100 may display the first use history 610a in which a user uses the internet browser application from 12 pm to 3 pm on October 17. The electronic device 100 may display a name 611a of the application and an internet address 612a to which the user accesses. As another example, the electronic device 100 may display the fourth use history 640a in which the user uses a PowerPoint application from 2 pm to 5 pm on October 18. The electronic device 100 may display a name 641a of the application, a file name 642a of the generated file, and a partial content 643a of the generated file.

According to an embodiment, as illustrated in FIG. 6B, the electronic device 100 may display user's use history 610b, 620b, and 630b in units of day. For example, the electronic device 100 may display the use history 610b of a user using the internet browser application and the game application (e.g., a starcraft) on October 17. In this case, the electronic device 100 may display only simpler contents than when displaying in units of time. For example, the electronic device 100 may display only the names 611b and 612b of the used application.

According to various embodiments of the disclosure, a form in which the electronic device 100 displays a user's use history is not limited to FIGS. 6A and 6B. For example, the form of the calendar may include a form divided into at least one unit of time unit, daily unit, weekly unit, or monthly unit.

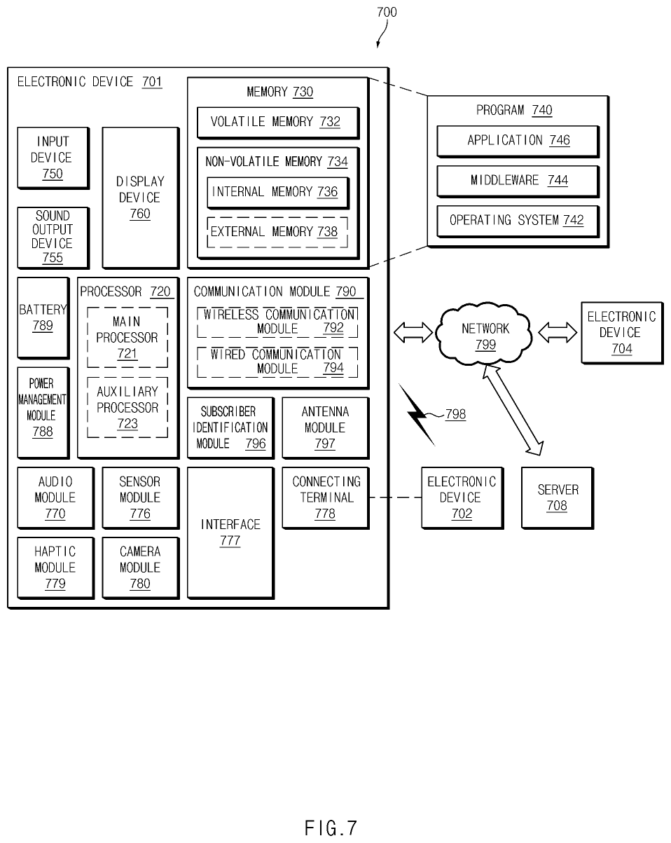

FIG. 7 is a block diagram of an electronic device 701 in a network environment 700 according to various embodiments.

Referring to FIG. 7, an electronic device 701 may communicate with an electronic device 702 through a first network 798 (e.g., a short-range wireless communication) or may communicate with an electronic device 704 or a server 708 through a second network 799 (e.g., a long-distance wireless communication) in a network environment 700. According to an embodiment, the electronic device 701 may communicate with the electronic device 704 through the server 708. According to an embodiment, the electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module 796, and an antenna module 797. According to some embodiments, at least one (e.g., the display device 760 or the camera module 780) among components of the electronic device 701 may be omitted or other components may be added to the electronic device 701. According to some embodiments, some components may be integrated and implemented as in the case of the sensor module 776 (e.g., a fingerprint sensor, an iris sensor, or an illuminance sensor) embedded in the display device 760 (e.g., a display).

The processor 720 may operate, for example, software (e.g., a program 740) to control at least one of other components (e.g., a hardware or software component) of the electronic device 701 connected to the processor 720 and may process and compute a variety of data. The processor 720 may load a command set or data, which is received from other components (e.g., the sensor module 776 or the communication module 790), into a volatile memory 732, may process the loaded command or data, and may store result data into a nonvolatile memory 734. According to an embodiment, the processor 720 may include a main processor 721 (e.g., a central processing unit or an application processor) and an auxiliary processor 723 (e.g., a graphic processing device, an image signal processor, a sensor hub processor, or a communication processor), which operates independently from the main processor 721, additionally or alternatively uses less power than the main processor 721, or is specified to a specified function. In this case, the auxiliary processor 723 may operate separately from the main processor 721 or embedded.

In this case, the auxiliary processor 723 may control, for example, at least some of functions or states associated with at least one component (e.g., the display device 760, the sensor module 776, or the communication module 790) among the components of the electronic device 701 instead of the main processor 721 while the main processor 721 is in an inactive (e.g., sleep) state or together with the main processor 721 while the main processor 721 is in an active (e.g., an application execution) state. According to an embodiment, the auxiliary processor 723 (e.g., the image signal processor or the communication processor) may be implemented as a part of another component (e.g., the camera module 780 or the communication module 790) that is functionally related to the auxiliary processor 723. The memory 730 may store a variety of data used by at least one component (e.g., the processor 720 or the sensor module 776) of the electronic device 701, for example, software (e.g., the program 740) and input data or output data with respect to commands associated with the software. The memory 730 may include the volatile memory 732 or the nonvolatile memory 734.

The program 740 may be stored in the memory 730 as software and may include, for example, an operating system 742, a middleware 744, or an application 746.

The input device 750 may be a device for receiving a command or data, which is used for a component (e.g., the processor 720) of the electronic device 701, from an outside (e.g., a user) of the electronic device 701 and may include, for example, a microphone, a mouse, or a keyboard.

The sound output device 755 may be a device for outputting a sound signal to the outside of the electronic device 701 and may include, for example, a speaker used for general purposes, such as multimedia play or recordings play, and a receiver used only for receiving calls. According to an embodiment, the receiver and the speaker may be either integrally or separately implemented.

The display device 760 may be a device for visually presenting information to the user of the electronic device 701 and may include, for example, a display, a hologram device, or a projector and a control circuit for controlling a corresponding device. According to an embodiment, the display device 760 may include a touch circuitry or a pressure sensor for measuring an intensity of pressure on the touch.

The audio module 770 may convert a sound and an electrical signal in dual directions. According to an embodiment, the audio module 770 may acquire the sound through the input device 750 or may output the sound through an external electronic device (e.g., the electronic device 702 (e.g., a speaker or a headphone)) wired or wirelessly connected to the sound output device 755 or the electronic device 701.

The sensor module 776 may generate an electrical signal or a data value corresponding to an operating state (e.g., power or temperature) inside or an environmental state outside the electronic device 701. The sensor module 776 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 777 may support a designated protocol wired or wirelessly connected to the external electronic device (e.g., the electronic device 702). According to an embodiment, the interface 777 may include, for example, an HDMI (high-definition multimedia interface), a USB (universal serial bus) interface, an SD card interface, or an audio interface.

A connecting terminal 778 may include a connector that physically connects the electronic device 701 to the external electronic device (e.g., the electronic device 702), for example, an HDMI connector, a USB connector, an SD card connector, or an audio connector (e.g., a headphone connector).

The haptic module 779 may convert an electrical signal to a mechanical stimulation (e.g., vibration or movement) or an electrical stimulation perceived by the user through tactile or kinesthetic sensations. The haptic module 779 may include, for example, a motor, a piezoelectric element, or an electric stimulator.

The camera module 780 may shoot a still image or a video image. According to an embodiment, the camera module 780 may include, for example, at least one lens, an image sensor, an image signal processor, or a flash.

The power management module 788 may be a module for managing power supplied to the electronic device 701 and may serve as at least a part of a power management integrated circuit (PMIC).

The battery 789 may be a device for supplying power to at least one component of the electronic device 701 and may include, for example, a non-rechargeable (primary) battery, a rechargeable (secondary) battery, or a fuel cell.

The communication module 790 may establish a wired or wireless communication channel between the electronic device 701 and the external electronic device (e.g., the electronic device 702, the electronic device 704, or the server 708) and support communication execution through the established communication channel. The communication module 790 may include at least one communication processor operating independently from the processor 720 (e.g., the application processor) and supporting the wired communication or the wireless communication. According to an embodiment, the communication module 790 may include a wireless communication module 792 (e.g., a cellular communication module, a short-range wireless communication module, or a GNSS (global navigation satellite system) communication module) or a wired communication module 794 (e.g., an LAN (local area network) communication module or a power line communication module) and may communicate with the external electronic device using a corresponding communication module among them through the first network 798 (e.g., the short-range communication network such as a Bluetooth, a WiFi direct, or an IrDA (infrared data association)) or the second network 799 (e.g., the long-distance wireless communication network such as a cellular network, an internet, or a computer network (e.g., LAN or WAN)). The above-mentioned various communication modules 790 may be implemented into one chip or into separate chips, respectively.

According to an embodiment, the wireless communication module 792 may identify and authenticate the electronic device 701 using user information stored in the subscriber identification module 796 in the communication network.

The antenna module 797 may include one or more antennas to transmit or receive the signal or power to or from an external source. According to an embodiment, the communication module 790 (e.g., the wireless communication module 792) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 701 and the external electronic device 704 through the server 708 connected to the second network 799. Each of the electronic devices 702 and 704 may be the same or different types as or from the electronic device 701. According to an embodiment, all or some of the operations performed by the electronic device 701 may be performed by another electronic device or a plurality of external electronic devices. When the electronic device 701 performs some functions or services automatically or by request, the electronic device 701 may request the external electronic device to perform at least some of the functions related to the functions or services, in addition to or instead of performing the functions or services by itself. The external electronic device receiving the request may carry out the requested function or the additional function and transmit the result to the electronic device 701. The electronic device 701 may provide the requested functions or services based on the received result as is or after additionally processing the received result. To this end, for example, a cloud computing, distributed computing, or client-server computing technology may be used.

An electronic device according to an embodiment disclosed in the disclosure includes a display, a memory, and a processor electrically connected to the display and the memory, and wherein the processor is configured to receive a first input of a user executing a first application, to execute at least one process for executing the first application in response to the received first input, to acquire first information including an ID and a start time of the executed at least one process, to receive a second input of the user executing a second application, and to display a name of the first application corresponding to the ID on the display in a form of a calendar in response to the received second input, based on the start time.

According to an embodiment, the first information may further include at least one of information on a file executed or generated in the executed first application from the start time, and the processor may be configured to display the name of the first application corresponding to the ID and the at least one of information on the display in the form of the calendar in response to the received second input, based on the start time.

According to an embodiment, the information on the executed or generated file may include at least one information of a file name of the executed or generated file, a modification time of the executed or generated file, a storage location of the executed or generated file, or a size of the executed or generated file.

According to an embodiment, the first application may be an internet browser application, and the first information may further include an internet address accessed on the internet browser application from the start time, and the processor may be configured to display the name of the first application corresponding to the ID and the accessed internet address on the display in the form of the calendar in response to the received second input, based on the start time.

According to an embodiment, the processor may be configured to store the first information in the memory.

According to an embodiment, the processor may be configured to receive a third input of the user terminating the first application, to terminate the at least one process in response to the received third input, to acquire second information including an ID and an end time of the terminated at least one process, and to display the name of the first application corresponding to the ID on the display in the form of the calendar in response to the received second input, based on the start time and the end time.

According to an embodiment, the second information may further include at least one of information on a file executed or generated in the first application from the start time to the end time, and the processor may be configured to display the name of the first application corresponding to the ID and at least one of information on the display in the form of the calendar in response to the received second input, based on the start time and the end time.

According to an embodiment, the information on the executed or generated file may include at least one information of a file name of the executed or generated file, a modification time of the executed or generated file, a storage location of the executed or generated file, or a size of the executed or generated file.

According to an embodiment, the first application may be an internet browser application, the second information may further include an internet address accessed on the internet browser application from the start time to the end time, and the processor may be configured to display the name of the first application corresponding to the ID and the internet address accessed to the end time on the display in the form of the calendar in response to the received second input, based on the start time and the end time.

According to an embodiment, the processor may be configured to store the first information and the second information in the memory.

According to an embodiment, the form of the calendar may include a form divided into at least one unit of a time unit, a daily unit, a weekly unit, or a monthly unit.

A method of displaying a use history of a user in a form of a calendar, according to an embodiment disclosed in the disclosure includes receiving a first input of the user executing a first application, executing at least one process for executing the first application in response to the received first input, acquiring first information including an ID and a start time of the executed at least one process, receiving a second input of the user executing a second application, and displaying a name of the first application corresponding to the ID on a display in the form of the calendar in response to the received second input, based on the start time.

According to an embodiment, the first information may further include at least one of information on a file executed or generated in the executed first application from the start time, and the displaying of the name of the first application in the form of the calendar may include displaying the name of the first application corresponding to the ID and the at least one information on the display in the form of the calendar in response to the received second input, based on the start time.

According to an embodiment, the information on the executed or generated file may include at least one information of a file name of the executed or generated file, a modification time of the executed or generated file, a storage location of the executed or generated file, or a size of the executed or generated file.

According to an embodiment, the method may further include storing the first information in the memory.

According to an embodiment, the method may further include receiving a third input of the user terminating the first application, terminating the at least one process in response to the received third input, and acquiring second information including an ID and an end time of the terminated at least one process, and the displaying of the name of the first application in the form of the calendar may include displaying the name of the first application corresponding to the ID on the display in the form of the calendar in response to the received second input, based on the start time and the end time.

According to an embodiment, the second information may further include at least one of information on a file executed or generated in the executed first application from the start time to the end time, and the displaying of the name of the first application in the form of the calendar may include displaying the name of the first application corresponding to the ID and the at least one of information on the display in the form of the calendar in response to the received second input, based on the start time and the end time.

According to an embodiment, the information on the executed or generated file may include at least one information of a file name of the executed or generated file, a modification time of the executed or generated file, a storage location of the executed or generated file, or a size of the executed or generated file.

According to an embodiment, the method may further include storing the first information and the second information in the memory.

According to an embodiment, the form of the calendar may include a form divided into at least one unit of a time unit, a daily unit, a weekly unit, or a monthly unit.

According to the embodiments disclosed in the disclosure, the electronic device may effectively provide a history of a task performed by a user through various applications. The electronic device may provide a user with high ease of use, and the user may increase work efficiency and continuity through this.

The electronic device according to various embodiments disclosed in the disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

It should be understood that various embodiments of the disclosure and terms used in the embodiments do not intend to limit technologies disclosed in the disclosure to the particular forms disclosed herein; rather, the disclosure should be construed to cover various modifications, equivalents, and/or alternatives of embodiments of the disclosure. With regard to description of drawings, similar components may be assigned with similar reference numerals. As used herein, singular forms may include plural forms as well unless the context clearly indicates otherwise. In the disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the disclosure may be implemented by software (e.g., the program 740) including an instruction stored in a machine-readable storage media (e.g., an internal memory 736 or an external memory 738) readable by a machine (e.g., a computer). The machine may be a device that calls the instruction from the machine-readable storage media and operates depending on the called instruction and may include the electronic device (e.g., the electronic device 701). When the instruction is executed by the processor (e.g., the processor 720), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the disclosure may be executed sequentially, in parallel, repeatedly, or in a heuristic method. Also, at least some operations may be executed in different sequences, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a display;
a memory; and
a processor electrically connected to the display and the memory, and
wherein the processor is configured to:
receive a first input of a user executing a first application;
execute at least one process for executing the first application in response to the received first input;
acquire first information including an ID and a start time of the executed at least one process;
receive a second input of the user executing a second application; and
display a name of the first application corresponding to the ID on the display in a form of a calendar in response to the received second input, based on the start time.

2. The electronic device of claim 1, wherein the first information further includes at least one of information on a file executed or generated in the executed first application from the start time, and
wherein, the processor is configured to display the name of the first application corresponding to the ID and the at least one of information on the display in the form of the calendar in response to the received second input, based on the start time.

3. The electronic device of claim 2, wherein the information on the executed or generated file includes at least one information of a file name of the executed or generated file, a modification time of the executed or generated file, a storage location of the executed or generated file, or a size of the executed or generated file.

4. The electronic device of claim 1, wherein the first application is an internet browser application,
wherein the first information further includes an internet address accessed on the internet browser application from the start time, and
wherein the processor is configured to display the name of the first application corresponding to the ID and the accessed internet address on the display in the form of the calendar in response to the received second input, based on the start time.

5. The electronic device of claim 1, wherein the processor is configured to store the first information in the memory.

6. The electronic device of claim 1, wherein the processor is configured to:
receive a third input of the user terminating the first application;
terminate the at least one process in response to the received third input;
acquire second information including an ID and an end time of the terminated at least one process; and
display the name of the first application corresponding to the ID on the display in the form of the calendar in response to the received second input, based on the start time and the end time.

7. The electronic device of claim 6, wherein the second information further includes at least one of information on a file executed or generated in the first application from the start time to the end time, and
wherein the processor is configured to display the name of the first application corresponding to the ID and at least one of information on the display in the form of the calendar in response to the received second input, based on the start time and the end time.

8. The electronic device of claim 7, wherein the information on the executed or generated file includes at least one information of a file name of the executed or generated file, a modification time of the executed or generated file, a storage location of the executed or generated file, or a size of the executed or generated file.

9. The electronic device of claim 6, wherein the first application is an internet browser application,
wherein the second information further includes an internet address accessed on the internet browser application from the start time to the end time, and
wherein the processor is configured to display the name of the first application corresponding to the ID and the internet address accessed to the end time on the display in the form of the calendar in response to the received second input, based on the start time and the end time.

10. The electronic device of claim 6, wherein the processor is configured to store the first information and the second information in the memory.

11. The electronic device of claim 1, wherein the form of the calendar includes a form divided into at least one unit of a time unit, a daily unit, a weekly unit, or a monthly unit.

12. A method of displaying a use history of a user in a form of a calendar, the method comprising:
receiving a first input of the user executing a first application;
executing at least one process for executing the first application in response to the received first input;
acquiring first information including an ID and a start time of the executed at least one process;
receiving a second input of the user executing a second application; and
displaying a name of the first application corresponding to the ID on a display in the form of the calendar in response to the received second input, based on the start time.

13. The method of claim 12, wherein the first information further includes at least one of information on a file executed or generated in the executed first application from the start time, and
wherein, the displaying of the name of the first application in the form of the calendar includes displaying the name of the first application corresponding to the ID and the at least one of information on the display in the form of the calendar in response to the received second input, based on the start time.

14. The method of claim 13, wherein the information on the executed or generated file includes at least one information of a file name of the executed or generated file, a modification time of the executed or generated file, a storage location of the executed or generated file, or a size of the executed or generated file.

15. The method of claim 12, further comprising:
storing the first information in the memory.
